(19) United States
(12) Patent Application Publication
(10) Pub. No.: US 2026/0046825 A1
(43) Pub. Date: Feb. 12, 2026

(54) MULTIPLE RADIO ACCESS TECHNOLOGY (RAT) COEXISTENCE MANAGEMENT

(71) Applicant: QUALCOMM Incorporated, San Diego, CA (US)

(72) Inventors: Shreya Satish NAYAK, San Diego, CA (US); Thawatt GOPAL, San Diego, CA (US)

(21) Appl. No.: 19/276,358

(22) Filed: Jul. 22, 2025

Related U.S. Application Data
(60) Provisional application No. 63/680,475, filed on Aug. 7, 2024.

(51) Int. Cl. H04W 64/00; H04W 52/14; H04W 72/0453; H04W 72/541

(52) U.S. Cl. CPC H04W 64/00; H04W 52/146; H04W 72/0453; H04W 72/541

(57) ABSTRACT

Certain aspects of the present disclosure provide techniques for wireless communications by an apparatus. A method includes determining the apparatus has active operations with each of a wireless local area network (WLAN), a global navigation satellite system (GNSS), and a radio frequency identification (RFID) system; determining current location information for the apparatus is unavailable from a source other than the GNSS; and based on the active operations and the unavailability of the current location information for the apparatus from a source other than the GNSS, performing coexistence management for the WLAN, GNSS, and RFID comprising to at least one of: reducing a transmit power used for WLAN operations; reducing a transmit power used for RFID operations; or changing a channel used for WLAN operations.

### CROSS-REFERENCE TO RELATED APPLICATION(S)

The present Application for Patent claims benefit of and priority to U.S. Provisional Application No. 63/680,475, filed Aug. 7, 2024, which is hereby expressly incorporated by reference herein in its entirety.

### INTRODUCTION

### Field of the Disclosure

Aspects of the present disclosure relate to wireless communications, and more particularly, to multiple radio access technology (RAT) coexistence.

### DESCRIPTION OF RELATED ART

Wireless communications systems are widely deployed to provide various telecommunication services such as telephony, video, data, messaging, broadcasts, etc. These wireless communications systems may employ multiple-access technologies capable of supporting communications with multiple users by sharing available wireless communications system resources with those users. Wireless communication devices may communicate RF signals via any of various suitable radio access technologies (RATs) including, but not limited to, 5G New Radio (NR), Evolved Universal Terrestrial Radio Access (E-UTRA), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., Institute of Electrical and Electronics Engineers (IEEE) 802.11 specifications), radio frequency identification (RFID) RATs, global navigation satellite system (GNSS) RATs (e.g., GPS, GLONASS, Galileo, etc.), any future RAT, and/or the like.

In certain cases, a wireless communications device is equipped with a radio frequency (RF) transceiver (also referred to as an RF front-end) for communicating RF signals. In some cases, a baseband signal is modulated to convey information using a modulation technique, such as phase-shift keying (PSK) or any other suitable modulation technique. In a transmit mode, the RF transceiver may be responsible for multiplexing the baseband signal with an RF carrier signal that is transmitted over the air (e.g., a wireless communication channel). Such an operation is called upconversion. In a receive mode, the RF transceiver may convert a received RF signal to the baseband signal. Such an operation is called downconversion. The received baseband signal then can be demodulated into the information encoded at a transmitter. The RF transceiver may include a cascade of components in a transmit chain and a receive chain, respectively. The cascade of components may include, for example, one or more of attenuators, switches, couplers, filters, mixers, amplifiers, frequency synthesizers, oscillators, antenna tuners, duplexers, diplexers, detectors, etc.

Although there have been great technological advancements in RF circuitry over many years, challenges still exist. For example, RF circuitry can still encounter interference, such as due to interference caused by supporting communications at different frequencies for multiple RATs. Accordingly, there is a continuous desire to improve the technical performance of RF circuitry, such as to mitigate interference.

### SUMMARY

One aspect provides a method for wireless communications by an apparatus. The method includes determining the apparatus has active operations with each of a wireless local area network (WLAN), a global navigation satellite system (GNSS), and a radio frequency identification (RFID) system; determining current location information for the apparatus is unavailable from a source other than the GNSS; and based on the active operations and the unavailability of the current location information for the apparatus from a source other than the GNSS, performing coexistence management for the WLAN, GNSS, and RFID comprising to at least one of: reducing a transmit power used for WLAN operations; reducing a transmit power used for RFID operations; or changing a channel used for WLAN operations.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 depicts an example wireless communications system.

FIG. 2 depicts an example wireless communications device communicating with another device.

FIG. 3 illustrates example components of a wireless device, which may be used to communicate with a wireless local area network (WLAN), a global navigation satellite system (GNSS), and a radio frequency identification (RFID) system.

FIG. 4 illustrates an example of frequencies used for communication with each of a WLAN, GNSS, and RFID system.

FIG. 5 illustrates example operations for wireless communication.

FIG. 6 illustrates example operations for wireless communication.

FIGS. 7A and 7B depict an example process flow for communications between GNSS circuitry, RFID circuitry, WLAN circuitry, and a coexistence manager.

FIG. 8 depicts an example method for wireless communications by an apparatus.

FIG. 9 depicts a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for coexistence management for multiple RATs.

Many wireless devices (e.g., user equipment (UE)) support communications using multiple different radio access technologies (RATs). For example, some wireless devices may be configured to support communication with each of a wireless local area network (WLAN), a global navigation satellite system (GNSS), and a radio frequency identification (RFID) system (e.g., backscatter communications). For example, the wireless device may communicate with a WLAN access point (AP), such as when in station (STA) mode, and/or operate in one or more other WLAN modes, such as a software enabled access point (SoftAP or hotspot) mode, a WLAN scanning mode, or a peer-to-peer WLAN connection mode. As another example, the wireless device may receive signals from a GNSS satellite, which the wireless device uses to calculate its location. As yet another example, the wireless device may act as an RFID reader, and transmit an RFID signal to an RFID tag, and receive a signal in return from the RFID tag.

In some cases, a wireless device may support communication with each of the WLAN, GNSS, and RFID system at a same time. For example, during a given time period the wireless device may have an active session with the RFID system, may have an active session with the GNSS, and may have WLAN circuitry powered on (e.g., and active).

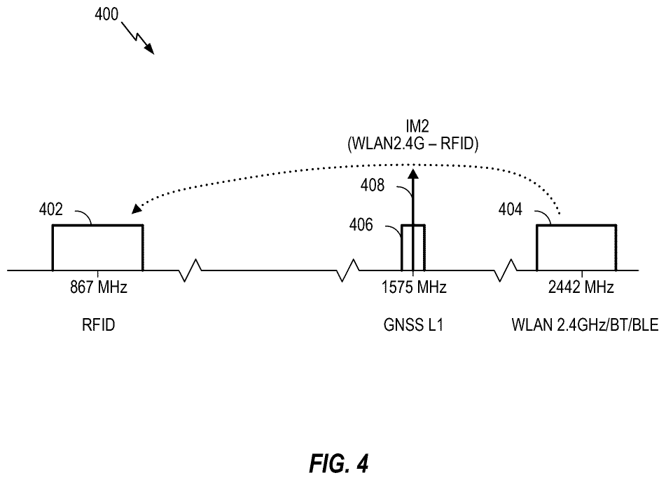

In some cases, technical problems may arise when the wireless device communicates with each of the WLAN, GNSS, and RFID system at the same time. In particular, transmission of signals from the wireless device for the WLAN and the RFID system may interfere with reception of signals by the wireless device for the GNSS. For example, FIG. 4 illustrates an example of frequencies 400 used for communication with each of the WLAN, GNSS, and RFID system. As shown, an RFID system may operate in a first frequency (e.g., 867 MHZ) of a first frequency band 402 (e.g., 865-925 MHZ) and the WLAN may operate in a second frequency (e.g., 2442 MHZ) of a second frequency band 404 (e.g., 2402-2494 MHZ). As the wireless device transmits in the first frequency band 402 and the second frequency band 404 for RFID and WLAN communications, respectively, certain distortions may form and occupy an intermodulation (IM) frequency 408, for example, due to cross-talk among circuitry in the wireless device and/or self-interference. As an example, the resulting IM frequency 408 (e.g., 1575 MHZ) of a second order IM of the first frequency and the second frequency may fall within an operating frequency band 406 of the GNSS (e.g., 1559-1610 MHZ, such as GNSS band L1). Intermodulation may refer to the modulation of signals containing two or more different frequencies, caused by nonlinearities or time variance in a system. The intermodulation between frequency components may form additional components at frequencies that are not just at harmonic frequencies (integer multiples) of either, like harmonic distortion, but also at the sum and difference frequencies of the original frequencies and at sums and differences of multiples of those frequencies. Therefore, in certain cases, the IM frequency 408 may interfere with the reception of GNSS signals in the operating frequency band 406 of the GNSS by the wireless device. For example, a GNSS receiver chain of a wireless device used for GNSS signal reception may be desensed (e.g., a degradation in sensitivity of the GNSS receiver may occur) at frequencies near the IM frequency, including the operating frequency band of the GNSS.

The interference causing desense of the GNSS receiver chain may in turn cause issues with location determination at the wireless device (e.g., device positioning). For example, the wireless device may rely on the GNSS receiver chain to receive signals from the GNSS by which to determine a location of the wireless device. The location information may be used by the wireless device for many different scenarios, such as navigation, geofencing, etc. Therefore, a technical problem for a wireless device that supports communication with a WLAN, GNSS, and RFID system is that simultaneous operations with the WLAN, GNSS, and RFID system can cause performance issues with the GNSS operations, leading to issues with determining wireless device location.

One technique for mitigating interference causing desense of the GNSS receiver chain, so as to reduce performance issues with the GNSS operations, is to add filters, such as to an RFID transmit chain of the wireless device used for transmission of signals in the RFID system. However, such additional filters may increase costs of the wireless device and require more hardware.

Accordingly, aspects herein provide techniques for selectively performing coexistence management at the wireless device for the WLAN, GNSS, and RFID system. Coexistence management may refer to adjusting one or more operating parameters (e.g., operating frequency, transmit power, etc.) of the wireless device for communications with the WLAN and/or RFID system, such as to reduce interference with communications of the wireless device with the GNSS, which may provide a technical solution to the technical problem of operating the WLAN, GNSS, and RFID system at the same time.

For example, in certain aspects, when the wireless device has active operations with each of the WLAN, GNSS, and RFID system (e.g., where the WLAN and RFID operations cause interference to the GNSS operations as discussed, such as based on the operating frequencies of each), the wireless device may be configured to determine whether location information of the wireless device is available to the wireless device from a source other than the GNSS. As an example, the location information may be available to the wireless device when it is in a connected stated (e.g., STA mode) with a WLAN access point (AP), for example, via a WLAN positioning system or service. For example, the WLAN access point may provide location information to the wireless device based on triangulation of signals sent from the wireless device to the WLAN AP. In certain aspects, when the location information is available to the wireless device from a source other than the GNSS, the wireless device may continue WLAN operations (e.g., transmission of signals in the WLAN) and RFID operations (e.g., transmission of signals in the RFID system) that may interfere with the GNSS operations (e.g., reception of signals from the GNSS). For example, the GNSS signals may not be needed for determining wireless device location. This may provide the technical benefit that WLAN and RFID operations may continue without reduced performance (e.g., lower signal to noise ratio, delay for changing a channel of operation, etc.) and maintain device positioning, when signals from the GNSS may not necessarily be needed.

In certain aspects, when the location information is not available to the wireless device from a source other than the GNSS, the wireless device may be configured to perform coexistence management for the WLAN, GNSS, and RFID system. In certain aspects, to perform coexistence management, the wireless device may be configured to reduce a transmit power used for WLAN operations, such as to reduce a signal strength at the IM frequency 408, thereby reducing interference with GNSS operations. In certain aspects, to perform coexistence management, the wireless device may be configured to reduce a transmit power used for RFID operations, such as to reduce a signal strength at the IM frequency 408, thereby reducing interference with GNSS operations. In certain aspects, to perform coexistence management, the wireless device may be configured to change a frequency (e.g., channel within a same frequency band the wireless device is currently configured to use, or channel within a different frequency band) used for WLAN operations, such as to change the IM frequency 408 to a frequency that has reduced or no interference with GNSS operations. This may provide the technical benefit that enables reliable and accurate device positioning through mitigating interference with GNSS signals to allow such GNSS signals to be received and successfully decoded by the wireless device for location determination.

### Example Wireless Communications System

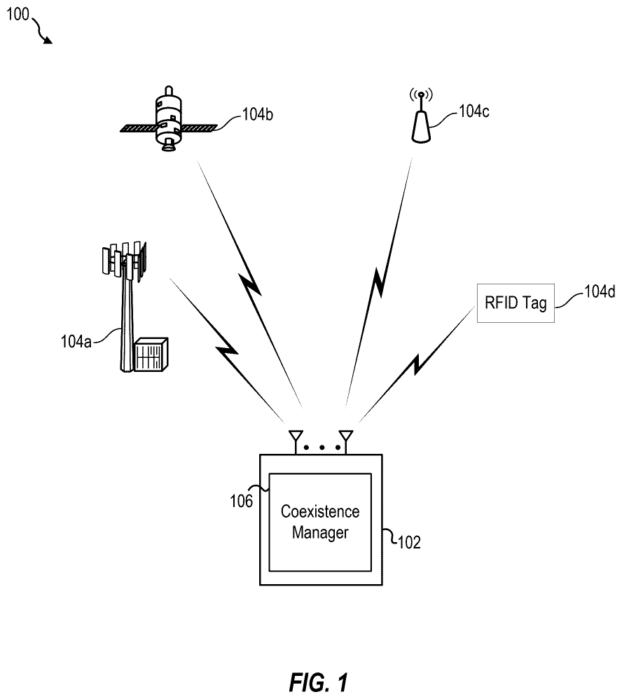

FIG. 1 illustrates an example wireless communications system 100 in which aspects of the present disclosure may be performed. For example, the wireless communications system may include multiple wireless communications systems, such as for multiple RATs, such as for one or more of: a wireless wide area network (WWAN), an RFID system, a GNSS, and/or a wireless local area network (WLAN). A WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communications system 100 may include a device-to-device (D2D) communications network or a short-range communications system, such as Bluetooth communications or near field communications (NFC).

As illustrated in FIG. 1, the wireless communications system 100 may include a first wireless device 102 communicating with any of various second wireless devices 104a-d (hereinafter “the second wireless device 104”) via any of various radio access technologies (RATs), where a wireless device may refer to a wireless communications device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), D2D communications, RFID communications, GNSS communications, etc.

The first wireless device 102 may include any of various wireless communications devices including a user equipment (UE), a base station, a wireless station, an access point, customer-premises equipment (CPE), etc. In certain aspects, the first wireless device 102 includes coexistence manager 106 that is configured to perform coexistence management for multiple RATs (e.g., WLAN, GNSS, and RFID) at first wireless device 102, in accordance with aspects of the present disclosure.

The second wireless device 104 may include, for example, a base station 104a (e.g., for WWAN), a satellite 104b (e.g., for GNSS), an access point (AP) 104c (e.g., for WLAN), and/or an RFID tag 104d (e.g., for RFID). The wireless communications system 100 may include terrestrial aspects, such as ground-based network entities (e.g., the base station 104a and/or access point 104c), and/or non-terrestrial aspects, such as a spaceborne platform (e.g., satellite 104b) and/or an aerial platform, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

According to some aspects, the wireless communications system 100 can include a WLAN, such as a Wi-Fi network. For example, the wireless communications system 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The wireless communications system 100 may include numerous wireless communication devices such as wireless AP(s) and STAs. For example, the first wireless device 102 and the second wireless device 104c may be representative of an AP and/or STA. As an example, in some cases, the first wireless device 102 may operate as an AP and/or a STA. The wireless communications system 100 can include multiple APs, including the AP 104c and/or the first wireless device 102. The AP can represent various different types of APs including but not limited to enterprise-level APs, single-frequency APs, dual-band APs, standalone APs, software-enabled APs (soft APs), and multi-link APs. The coverage area and capacity of a cellular network (such as E-UTRA, 5G NR, etc.) can be further improved by a small cell which is supported by an AP serving as a miniature base station. Furthermore, private cellular networks also can be set up through a wireless area network using small cells.

A single AP and an associated set of STAs may be referred to as a basic service set (BSS), which is managed by the respective AP. The coverage area of the AP may represent a basic service area (BSA) of the wireless communications system 100. The BSS may be identified or indicated to users by a service set identifier (SSID), as well as to other devices by a basic service set identifier (BSSID), which may be a medium access control (MAC) address of the AP. The AP may periodically broadcast beacon frames (“beacons”) including the BSSID to enable any STAs within wireless range of the AP to “associate” or re-associate with the AP to establish a respective communication link, or to maintain a communication link, with the AP. For example, the beacons can include an identification or indication of a primary channel used by the respective AP as well as a timing synchronization function for establishing or maintaining timing synchronization with the AP. The AP may provide access to external networks to various STAs in the WLAN via respective communication links.

To establish a communication link with an AP, each of the STAs is configured to perform passive or active scanning operations (“scans”) (e.g., in a WLAN scanning mode) on frequency channels in one or more frequency bands (for example, the 2.4 GHZ, 5 GHz, 6 GHZ, or 60 GHz bands). To perform passive scanning, a STA listens for beacons, which are transmitted by respective APs at a periodic time interval referred to as the target beacon transmission time (TBTT) (measured in time units (TUs) where one TU may be equal to 1024 microseconds (μs)). To perform active scanning, a STA generates and sequentially transmits probe requests on each channel to be scanned and listens for probe responses from APs. Each STA may identify, determine, ascertain, or select an AP with which to associate in accordance with the scanning information obtained through the passive or active scans, and to perform authentication and association operations to establish a communication link with the selected AP. The AP assigns an association identifier (AID) to the STA at the culmination of the association operations, which the AP uses to track the STA.

As a result of the increasing ubiquity of wireless networks, a STA may have the opportunity to select one of many BSSs within range of the STA or to select among multiple APs that together form an extended service set (ESS) including multiple connected BSSs. An extended network station associated with the wireless communications system 100 may be connected to a wired or wireless distribution system that may allow multiple APs to be connected in such an ESS. As such, a STA can be covered by more than one AP and can associate with different APs at different times for different transmissions. Additionally, after association with an AP, a STA also may periodically scan its surroundings to find a more suitable AP with which to associate. For example, a STA that is moving relative to its associated AP may perform a “roaming” scan to find another AP having more desirable network characteristics such as a greater received signal strength indicator (RSSI) or a reduced traffic load.

In some cases, STAs may form networks without APs or other equipment other than the STAs themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the wireless communications system 100. In such examples, while the STAs may be capable of communicating with each other through the AP using communication links, STAs also can communicate directly with each other via direct wireless communication links. For example, the first wireless device 102 may communicate directly with a UE via WLAN communications (or other P2P communications, e.g., Bluetooth). Additionally, two STAs may communicate via a direct communication link regardless of whether both STAs are associated with and served by the same AP. In such an ad hoc system, one or more of the STAs may assume the role filled by the AP in a BSS. Such a STA may be referred to as a group owner (GO) and may coordinate transmissions within the ad hoc network. Examples of direct wireless communication links include Wi-Fi Direct connections, connections established by using a Wi-Fi Tunneled Direct Link Setup (TDLS) link, and other P2P group connections. In some cases, the first wireless device 102 may be capable of communicating with multiple peers including STA(s) and/or AP(s).

The APs and STAs may function and communicate (via the respective communication links) according to one or more of the IEEE 802.11 family of wireless communication protocol standards. These standards define the WLAN radio and baseband protocols for the physical (PHY) and medium access control (MAC) layers. The APs and STAs transmit and receive wireless communications (hereinafter also referred to as “wireless packets”) to and from one another in the form of PHY protocol data units (PPDUs). The APs and STAs in the wireless communications system 100 may transmit PPDUs over an unlicensed or shared spectrum, which may be a portion of spectrum that includes frequency bands used by WLAN technology, such as the 2.4 GHz band, the 5 GHz band, the 60 GHz band, the 3.6 GHz band, and the 900 MHz band. Some examples of the APs and STAs described herein also may communicate in other frequency bands, such as the 5.9 GHZ and the 6 GHz bands, which may support both licensed and unlicensed communications. The APs and STAs also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

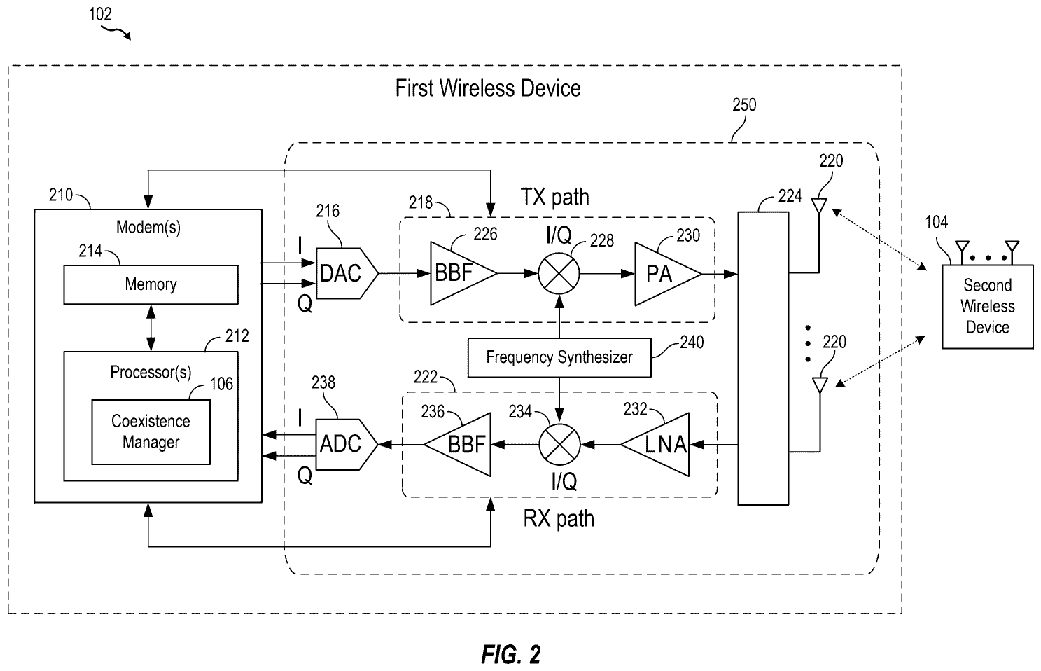

FIG. 2 illustrates example components of the first wireless device 102, which may be used to communicate with any of the second wireless devices 104.

The first wireless device 102 may be, or may include, a chip, system on chip (SoC), system in package (SiP), chipset, package, device that includes one or more modems 210 (hereinafter “the modem 210”). In some cases, the modem 210 may include, for example, any of a WWAN modem (e.g., a modem configured to communicate via E-UTRA 5G NR, and/or any future WWAN communications standards), a WLAN modem (e.g., a modem configured to communicate via IEEE 802.11 standards), a Bluetooth modem, a NTN modem, an RFID modem, a GNSS modem, etc. In certain aspects, the first wireless device 102 includes a first modem (e.g., one chip) configured to operate as a WLAN modem and a GNSS modem, and a second modem (e.g., one chip) configured to operate as an RFID modem (in some cases the second modem could also implement WWAN communications such that that the same mode may facilitate both WWAN and RFID communications). In certain aspects, the first wireless device 102 includes a first modem (e.g., one chip) configured to operate as an RFID modem and a GNSS modem, and a second modem (e.g., one chip) configured to operate as a WLAN modem. In certain aspects, the first wireless device 102 includes a first modem (e.g., one chip) configured to operate as a WLAN modem, a GNSS modem, and an RFID modem. In certain aspects, the first wireless device 102 includes a first modem (e.g., one chip) configured to operate as an RFID modem, a second modem (e.g., one chip) configured to operate as a GNSS modem, and a third modem (e.g., one chip) configured to operate as a WLAN modem. In certain aspects, the first wireless device 102 also includes one or more RF transceivers (hereinafter “the RF transceiver 250”). In some cases, the RF transceiver 250 may be referred to as an RF front end (RFFE). In some aspects, the modem 210 further includes one or more processors, processing blocks or processing elements (hereinafter “the processor 212”) and one or more memory blocks or elements (hereinafter “the memory 214”). In some cases, the processor 212 may implement and/or include the coexistence manager 106. In certain aspects, the processor 212 and/or the memory 214 are implemented external or otherwise separate from the modem 210.

In certain aspects, the processor 212 may process any of certain protocol stack layers associated with a radio access technology (RAT). For example, the processor 212 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer).

The modem 210 may generally be configured to implement a physical (PHY) layer. For example, the modem 210 may be configured to modulate packets and to output the modulated packets to the RF transceiver 250 for transmission over a wireless medium. The modem 210 is similarly configured to obtain modulated packets received by the RF transceiver 250 and to demodulate the packets to provide demodulated packets. In addition to a modulator and a demodulator, the modem 210 may further include digital signal processing (DSP) circuitry, automatic gain control (AGC), a coder, a decoder, a multiplexer, and/or a demultiplexer (not shown).

As an example, while in a transmission mode, the modem 210 may obtain data from a data source, such as an application processor. The data may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 216. In certain aspects involving beamforming, the modulated symbols in the respective spatial streams may be precoded via a steering matrix prior to provision to the IFFT block.

The modem 210 may be coupled to the RF transceiver 250 by a transmit (TX) path 218 (also known as a transmit chain) for transmitting signals via one or more antennas 220 (hereinafter “the antennas 220”) and a receive (RX) path 222 (also known as a receive chain) for receiving signals via the antennas 220. When the TX path 218 and the RX path 222 share the antennas 220, the paths may be coupled to the antennas 220 via an interface 224, which may include any of various suitable RF devices, such as a balun, a transformer, an antenna tuner, a switch, a duplexer, a diplexer, a multiplexer, and or like. As an example, the modem 210 may output digital in-phase (I) and/or quadrature (Q) baseband signals representative of the respective symbols to the DAC 216. In some examples, all or most of the elements illustrated as being included in the RF transceiver 250 are implemented in a single chip or die. For example, in some configurations, all of the elements of the RF transceiver except the antennas 220 are implemented on a single chip. In some other configurations, the interface 224 or a portion thereof is also omitted from the single chip.

Receiving I or Q baseband analog signals from the DAC 216, the TX path 218 may include a baseband filter (BBF) 226, a mixer 228 (which may include one or several mixers), and a power amplifier (PA) 230. The BBF 226 filters the baseband signals received from the DAC 216, and the mixer 228 mixes the filtered baseband signals with a transmit local oscillator (LO) signal to convert the baseband signal to a different frequency (e.g., upconvert from a baseband frequency to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 228 are typically RF signals, which may be amplified by the PA 230 before transmission by the antennas 220. The antennas 220 may emit RF signals, which may be received at the second wireless device 104. While one mixer 228 is illustrated, several mixers may be used to upconvert the filtered baseband signals to one or more intermediate frequencies and to thereafter upconvert the intermediate frequency signals to a frequency for transmission.

The RX path 222 may include a low noise amplifier (LNA) 232, a mixer 234 (which may include one or several mixers), and a baseband filter (BBF) 236. RF signals received via the antennas 220 (e.g., from the second wireless device 104) may be amplified by the LNA 232, and the mixer 234 mixes the amplified RF signals with a receive local oscillator (LO) signal to convert the RF signal to a baseband frequency (e.g., downconvert the RF signal to the baseband frequency). The baseband signals output by the mixer 234 may be filtered by the BBF 236 before being converted by an analog-to-digital converter (ADC) 238 to digital I or Q signals for digital signal processing. The modem 210 may receive the digital I or Q signals and further process the digital signals, for example, demodulating the digital signals into information.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 240, which may be buffered or amplified by an amplifier (not shown) before being mixed with the baseband signals in the mixer 228. Similarly, the receive LO frequency may be produced by the frequency synthesizer 240, which may be buffered or amplified by an amplifier (not shown) before being mixed with the RF signals in the mixer 234. Separate frequency synthesizers may be used for the TX path 218 and the RX path 222.

While in a reception mode, the modem 210 may obtain digitally converted signals via the ADC 238 and RX path 222. As an example, in the modem 210, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 212) for processing, evaluation, or interpretation.

The modem 210 and/or processor 212 may control the transmission of signals via the TX path 218 and/or reception of signals via the RX path 222. In some aspects, the modem 210 and/or processor 212 may be configured to perform various operations, such as those associated with any of the methods described herein. The modem 210 and/or processor 212 may include a microcontroller, a microprocessor, an application processor, a baseband processor, a MAC processor, an artificial intelligence (AI) processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 214 may store data and program codes (e.g., processor-readable instructions) for performing wireless communications as described herein. In some cases, the memory 214 may be external to the modem 210 and/or processor 212 and/or incorporated therein (as illustrated with the memory 214 or being incorporated with the processor 212).

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

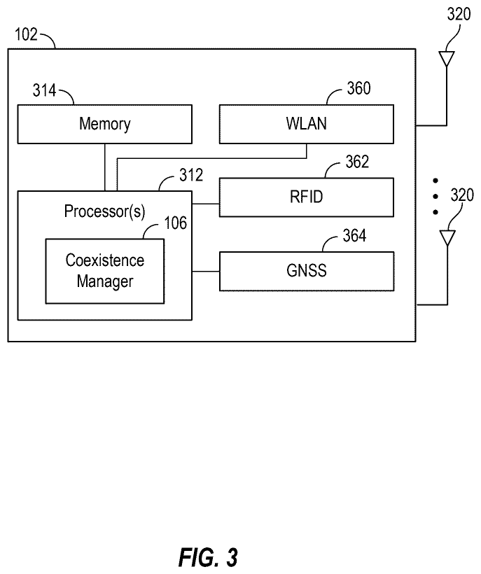

FIG. 3 illustrates example components of the first wireless device 102, which may be used to communicate with a WLAN, a GNSS, and an RFID system. The example of the first wireless device 102 as shown in FIG. 3 may include one or more of the components discussed with respect to FIG. 2.

As shown in FIG. 3, the first wireless device 102 includes one or more processors, processing blocks or processing elements (hereinafter “the processor 312”) (e.g., the processor 212 of FIG. 2) and one or more memory blocks or elements (hereinafter “the memory 314”) (e.g., the memory 214 of FIG. 2). In some cases, the processor 312 may implement and/or include the coexistence manager 106. As shown, the processor 312 is coupled to WLAN circuitry 360, RFID circuitry 362, and GNSS circuitry 364. Processor 312 (e.g., running or implementing coexistence manager 106) may be configured to control one or more of WLAN circuitry 360, RFID circuitry 362, and GNSS circuitry 364 as further discussed herein, such as to perform coexistence management between the WLAN circuitry 360, RFID circuitry 362, and GNSS circuitry 364 for communication with the WLAN, GNSS, and RFID system.

In certain aspects, WLAN circuitry 360 includes circuitry to facilitate communication with a WLAN (e.g., a WLAN AP, another WLAN device in peer-to-peer communication, another WLAN device where the first wireless device 102 is operating as a SoftAP, etc.). For example, the WLAN circuitry 360 may include a transmit chain (e.g., TX path 218 of FIG. 2) for transmitting signals in the WLAN and/or a receive chain (e.g., RX path 222 of FIG. 2) for receiving signals in the WLAN. For example, the transmit chain and the receive chain of the WLAN circuitry 360 may be part of an RF transceiver (e.g., RF transceiver 250 of FIG. 2) of the WLAN circuitry 360.

In certain aspects, RFID circuitry 362 includes circuitry to facilitate communication with an RFID system (e.g., with an RFID tag, such as where the first wireless device 102 is operating as an RFID reader). For example, the RFID circuitry 362 may include a transmit chain (e.g., TX path 218 of FIG. 2) for transmitting signals to the RFID tag and/or a receive chain (e.g., RX path 222 of FIG. 2) for receiving signals from the RFID tag. For example, the transmit chain and the receive chain of the RFID circuitry 362 may be part of an RF transceiver (e.g., RF transceiver 250 of FIG. 2) of the RFID circuitry 362. In some cases, a portion of the WWAN transceiver circuitry such as components of the RF transceiver 250 of FIG. 2 (e.g., a WWAN PA such as a GSM PA and other circuitry such as a WWAN antenna) may implement the RFID circuitry 362. In some aspects, the WWAN modem implementing the RFID circuitry may facilitate coexistence management as the WWAN modem may have existing functionality or the ability to more easily implement functionality for determining states and information about the WLAN circuitry 360 and/or the GNSS circuitry 364 or exchanging or receiving information about the WLAN circuitry 360 and/or the GNSS circuitry 364 for the purpose of management coexistence.

In certain aspects, GNSS circuitry 364 includes circuitry to facilitate communication with a GNSS system (e.g., a GNSS satellite). For example, the GNSS circuitry 364 may include a receive chain (e.g., RX path 222 of FIG. 2) for receiving signals from the GNSS satellite. For example, the receive chain of the GNSS circuitry 364 may be part of an RF transceiver (e.g., RF transceiver 250 of FIG. 2) of the GNSS circuitry 364.

In certain aspects, one or more antennas 320 may be shared by one or more of WLAN circuitry 360, RFID circuitry 362, and/or GNSS circuitry 364 for communications. In certain aspects, one or more of WLAN circuitry 360, RFID circuitry 362, and/or GNSS circuitry 364 may have one or more dedicated antennas 320 for communication, not shared with the other circuitry. In certain aspects, the techniques herein may be used for reducing interference that arises in any such cases.

In certain aspects, the WLAN circuitry 360, RFID circuitry 362, and GNSS circuitry 364 may at least in part be implemented on a same SoC, SiP, chipset, or package, and or share one or more components, which may increase the effects of interference discussed herein between the circuitry, such that the techniques herein provide a technical solution to addressing interference while still enabling the circuitry to be implemented accordingly. In certain aspects, one or more of the WLAN circuitry 360, RFID circuitry 362, and GNSS circuitry 364 may be implemented on separate SoCs, SiPs, chipsets, or packages. In certain aspects, the techniques herein may be used for reducing interference that arises in any such cases.

In certain aspects, transmission of signals on the WLAN circuitry 360 and the RFID circuitry 362 may interfere with reception of signals on the GNSS circuitry 364. For example, transmission of signal(s) at a first frequency on the WLAN circuitry 360, and transmission of signal(s) at a second frequency on the RFID circuitry 362, may interfere with reception of signal(s) at a third frequency on the GNSS circuitry 364. In particular, an intermodulation frequency based on the first frequency and the second frequency may equal or be near (within a threshold of) the third frequency, and thus interfere with the third frequency.

In certain aspects, first wireless device 102, such as processor 312 (e.g., implementing coexistence manager 106) is configured to perform coexistence management between WLAN circuitry 360, RFID circuitry 362, and GNSS circuitry 364, such as by at least one of: controlling RFID circuitry 362 to reduce a transmit power used for transmission of signals by RFID circuitry 362 (e.g., via a transmit chain of the RFID circuitry 362), controlling WLAN circuitry 360 to reduce a transmit power used for transmission of signals by WLAN circuitry 360 (e.g., via a transmit chain of the WLAN circuitry 360), or controlling WLAN circuitry 360 to change a frequency (e.g., channel) used for transmission of signals by WLAN circuitry 360 (e.g., via a transmit chain of the WLAN circuitry 360). In certain aspects, the WLAN circuitry 360 is changed to using a frequency (e.g., channel) in a same frequency range as currently used for communication in the WLAN. For example, the WLAN circuitry 360 may change from a first channel to a second channel both in the frequency range of 2402 MHZ-2494 MHz. In certain aspects, the WLAN circuitry 360 is changed to using a frequency (e.g., channel) in a different frequency range than currently used for communication in the WLAN. For example, the WLAN circuitry 360 may change from a first channel in the frequency range of 2402 MHz-2494 MHz to a second channel in the frequency range of 5150 MHz-5170 MHz.

In certain aspects, first wireless device 102 may be configured to prioritize WLAN circuitry 360 over RFID circuitry 362, such that for coexistence management, first wireless device 102 is configured to control RFID circuitry 362 to reduce a transmit power used for transmission of signals by RFID circuitry 362.

In certain aspects, first wireless device 102 may be configured to prioritize RFID circuitry 362 over WLAN circuitry 360, such that for coexistence management, first wireless device 102 is configured to control WLAN circuitry 360 to reduce a transmit power used for transmission of signals by WLAN circuitry 360 and/or control WLAN circuitry 360 to change a frequency (e.g., channel) used for transmission of signals by WLAN circuitry 360.

In certain aspects, for coexistence management, first wireless device 102 may be configured to both control RFID circuitry 362 to reduce a transmit power used for transmission of signals by RFID circuitry 362 and control WLAN circuitry 360 to reduce a transmit power used for transmission of signals by WLAN circuitry 360.

In certain aspects, for coexistence management, first wireless device 102 may be configured to, when possible, control WLAN circuitry 360 to change a frequency (e.g., channel) used for transmission of signals by WLAN circuitry 360. In certain aspects, when first wireless device 102 is not able to change a frequency (e.g., channel) used for transmission of signals by WLAN circuitry 360, first wireless device 102 may be configured to reduce a transmit power used for transmission of signals by RFID circuitry 362 (or reduce a transmit power used for transmission of signals by WLAN circuitry 360). For example, first wireless device 102 (e.g., processor 312) may be configured to determine if a non-conflicting channel for communication with the WLAN is available. A non-conflicting channel may be a frequency, such that the frequency and an IM frequency based on the frequency and another frequency used for the RFID circuitry 362 does not conflict with a GNSS frequency used for communication by the GNSS circuitry 364. In some aspects, such a non-conflicting channel may not be available for use because all such non-conflicting channels are busy or otherwise unavailable for communication by the first wireless device 102. In some aspects, such a non-conflicting channel may not be available for use because the first wireless device 102 is in a protocol mode or operating mode that does not allow the first wireless device 102 to select a channel (e.g., the channel is chosen for the first wireless device 102 such as by another device).

### Example Wireless Device Operations for Coexistence Management

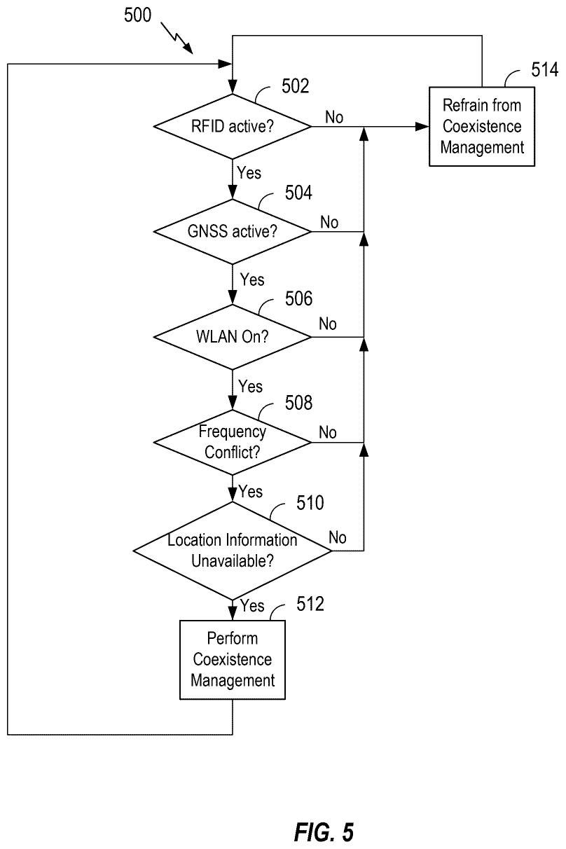

FIG. 5 illustrates example operations 500 for wireless communication. The operations 500 may be performed, for example, by a wireless device (e.g., the first wireless device 102 in the wireless communications system 100). The operations 500 may be implemented as software components that are executed and run on one or more processors (e.g., the modem 210 and/or the processor 212 of FIG. 2, the processor 312 of FIG. 3, etc.). Further, the transmission and/or reception of signals by the wireless device in the operations 500 may be enabled, for example, by one or more antennas (e.g., the antenna 220 of FIG. 2 or antenna 320 of FIG. 3) and/or circuitry (e.g., WLAN circuitry 360, RFID circuitry 362, and/or GNSS circuitry 364 of FIG. 3). In certain aspects, the transmission and/or reception of signals by the wireless device may be implemented via a bus interface of one or more processors (e.g., the modem 210 and/or the processor 212 of FIG. 2, the processor 312 of FIG. 3, etc.) obtaining and/or outputting signals for reception or transmission.

At 502, the wireless device determines (e.g., checks) if the wireless device has active operations with an RFID system. For example, the wireless device may have active operations with an RFID system when (e.g., at a time at which) one or more of: the wireless device has an on-going RFID session with an RFID tag; the RFID circuitry is actively transmitting (or expected to transmit in a transmission occasion); or the like.

If at 502, the wireless device determines it has active operations with an RFID system, at 504, the wireless device determines if it has active operations with a GNSS. For example, the wireless device may have active operations with the GNSS when (e.g., at a time at which) one or more of: the wireless device has an active GNSS session; the wireless device is locking onto a GNSS satellite; the GNSS circuitry is actively receiving (or expected to receive in the transmission occasion of the RFID system and/or WLAN); or the like.

If at 504, the wireless device determines it has active operations with the GNSS, at 506, the wireless device determines if it has active operations with a WLAN. For example, the wireless device may have active operations with the WLAN when (e.g., at a time at which) one or more of: the WLAN (e.g., WLAN circuitry 360) is switched on (e.g., the WLAN circuitry 360 is actively transmitting or expected to transmit in the transmission occasion of the RFID system and/or WLAN); the wireless device is operating in an STA mode; the wireless device is operating in a SoftAP mode; the wireless device is operating in a WLAN scanning mode; the wireless device is operating in a peer-to-peer WLAN connection mode; or the like.

If at 506, the wireless device determines it has active operations with a WLAN, optionally, at 508, the wireless device determines if there is a frequency conflict between the WLAN operations, RFID operations, and GNSS operations. In certain aspects, 508 is optional, as based on the active WLAN operations, RFID operations, and GNSS operations, the wireless device assumes there is a frequency conflict between the WLAN operations, RFID operations, and GNSS operations.

In certain aspects, to determine if there is a frequency conflict between the WLAN operations, RFID operations, and GNSS operations, the wireless device determines a first frequency associated with the WLAN operations (e.g., a frequency used for transmission of signals in the WLAN), a second frequency associated with the RFID operations (e.g., a frequency used for transmission of signals in the RFID system); and a third frequency associated with the GNSS operations (e.g., a frequency used for reception of signals in the GNSS).

In certain aspects, the wireless device determines if an intermodulation frequency of the first frequency and the second frequency interferes with (e.g., is equal to or within a threshold of) the third frequency, for example, as described herein with respect to FIG. 4. If the wireless device determines the intermodulation frequency of the first frequency and the second frequency interferes with the third frequency, the wireless device may determine there is a frequency conflict. If the wireless device determines the intermodulation frequency of the first frequency and the second frequency does not interfere with the third frequency, the wireless device may determine there is not a frequency conflict. In certain aspects, wireless device determines if an intermodulation frequency of the first frequency and the second frequency interferes with the third frequency based on mathematical characterizations of the intermodulation frequency (e.g., first frequency−second frequency=IM frequency).

In certain aspects, the wireless device determines if the intermodulation frequency of the first frequency and the second frequency interferes with the third frequency based on a lookup table or other data structure that indicates whether the combination of values for the first frequency, the second frequency, and the third frequency interfere with one another. For example, offline desense characterization or testing, simulations, numerical evaluation, etc., may be performed to determine which combination of values for the first frequency, the second frequency, and the third frequency interfere with one another, and the results stored in a data structure. In certain aspects, the wireless device determines if the intermodulation frequency of the first frequency and the second frequency interferes with the third frequency based at least in part on an evaluation of a received signal strength and/or a received signal quality of the GNSS signal. As an example, if the received signal strength (e.g., the received signal strength indicator (RSSI)) of the GNSS signal is relatively high (for example, above a threshold signal strength), and if the received signal quality (e.g., the signal-to-noise ratio) is relatively low (e.g., below a threshold signal quality), then the received signal strength and the received signal quality may indicate that there is a frequency conflict between the WLAN operations, RFID operations, and GNSS operations. If at 508, the wireless device determines there is a frequency conflict between the WLAN operations, RFID operations, and GNSS operations, operations 500 continue to 510.

At 510, the wireless device determines if current location information for the wireless device is unavailable from a source other than the GNSS. In certain aspects, as discussed, current location information for the wireless device may be available from another source, such as a WLAN AP (or a WLAN positioning system or service), when the wireless device is connected to a WLAN AP, such as when the wireless device is in STA mode. As an example, a WLAN positioning system may have a database of geolocations associated with WLAN APs. The position of the wireless device may be determined using the channel characteristics (e.g., received signal strengths) associated with WLAN AP(s) discovered by the wireless device and the identifiers associated with the discovered WLAN AP(s) (such as the SSID and MAC address). The wireless device may obtain, from the WLAN positioning system, the geolocation of the discovered WLAN AP(s) based on the corresponding AP identifier(s), and the wireless device may determine its position relative to the discovered WLAN AP(s), for example, through received signal strength localization or the like. The wireless device may be in one or more other modes with the WLAN as well, such as SoftAP mode, peer-to-peer communication mode, etc., but so long as it is connected to a WLAN AP, such as in STA mode, the wireless device may be able to receive or determine location information for the wireless device from the WLAN AP and/or via the WLAN positioning system or service. Accordingly, in certain aspects, the wireless device determines if current location information for the wireless device is unavailable from a source other than the GNSS based on whether the wireless device is connected to a WLAN AP or the WLAN positioning system. In certain aspects, if the wireless device is not connected to a WLAN AP (for example, the wireless device is unable to successfully discover or establish a connection with the WLAN AP and/or the WLAN positioning system), the wireless device determines current location information for the wireless device is unavailable from a source other than the GNSS. In certain aspects, if the wireless device is connected to a WLAN AP, the wireless device determines current location information for the wireless device is available from a source other than the GNSS.

If any of the criteria at 502-510 are determined as not being true or satisfied, operations 500 may proceed to 514, where the wireless device does not perform (e.g., refrains from performing) coexistence management.

If at 510, the wireless device determines current location information for the wireless device is unavailable from a source other than the GNSS, the wireless device may perform coexistence management at 512, as discussed herein.

In certain aspects, to perform coexistence management, the wireless device may be configured to reduce a transmit power used for WLAN operations, thereby reducing interference with GNSS operations. In certain aspects, to perform coexistence management, the wireless device may be configured to reduce a transmit power used for RFID operations, thereby reducing interference with GNSS operations. In certain aspects, to perform coexistence management, the wireless device may be configured to change a frequency (e.g., channel within a same frequency band the wireless device is currently configured to use, or channel within a different frequency band) used for WLAN operations, such as to change an IM frequency to a frequency that has reduced or no interference with GNSS operations.

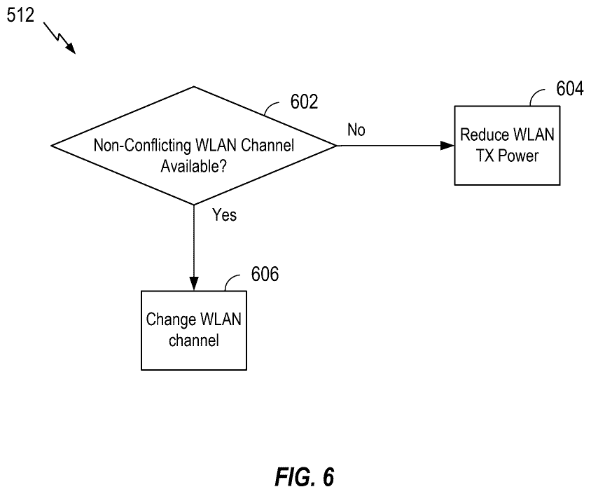

FIG. 6 illustrates an example of operations for performing coexistence management at 512 of FIG. 5.

At 602, the wireless device determines whether a non-conflicting channel for the WLAN operations with respect to GNSS operations is unavailable. For example, a non-conflicting channel may be a frequency that, together with a frequency for RFID operations (e.g., IM frequency of the two frequencies), does not interfere with the GNSS operations (e.g., GNSS frequency). In some aspects, such a non-conflicting channel may not be available for use because all such non-conflicting channels are busy or otherwise unavailable for communication by the wireless device. In some aspects, such a non-conflicting channel may not be available for use because the wireless device is in a protocol mode or operating mode that does not allow the wireless device to select a channel (e.g., the channel is chosen for the wireless device such as by another device). For example, a wireless device may be able to select a channel when operating in a peer-to-peer go communication mode or SoftAP mode, but not in a peer-to-peer client mode.

If at 602, the wireless device determines a non-conflicting channel for the WLAN operations with respect to GNSS operations is available, at 606, the wireless device changes a channel for WLAN operations to a non-conflicting channel.

If at 602, the wireless device determines a non-conflicting channel for the WLAN operations with respect to GNSS operations is not available, at 604, the wireless device may reduce a transmit power for WLAN operations (and/or reduce a transmit power for RFID operations.

In certain aspects, if the wireless device, such as at 502, later determines that RFID operations become inactive, as in active operations have stopped, the wireless device may cease performance of coexistence management, such as no longer reduce transmit power of WLAN and/or RFID operations and/or change a channel for WLAN operations to a previously used channel.

In certain aspects, if the wireless device, such as at 504, later determines that GNSS operations become inactive, the wireless device may cease performance of coexistence management.

In certain aspects, if the wireless device, such as at 506, later determines that WLAN operations become inactive, the wireless device may cease performance of coexistence management.

In certain aspects, if the wireless device, such as at 508, later determines that there is no frequency conflict between WLAN, RFID, and GNSS operations, the wireless device may cease performance of coexistence management.

In certain aspects, if the wireless device, such as at 510, later determines that location information is available from a source other than GNSS, the wireless device may cease performance of coexistence management.

Note that the operations 500 illustrated in FIG. 5 and/or FIG. 6 are an example of coexistence management, and aspects of the present disclosure may be applied to additional or alternative techniques for coexistence management. Note that the operations 500 are described herein to facilitate an understanding of coexistence management, and aspects of the present disclosure may be performed in various manners via alternative or additional signaling and/or operations. In certain aspects, the operations and/or signaling of FIG. 5 and/or FIG. 6 may occur in an order different from that described or depicted, and various actions, operations, and/or signaling may be added, omitted, or combined.

### Example Signaling of Coexistence Management

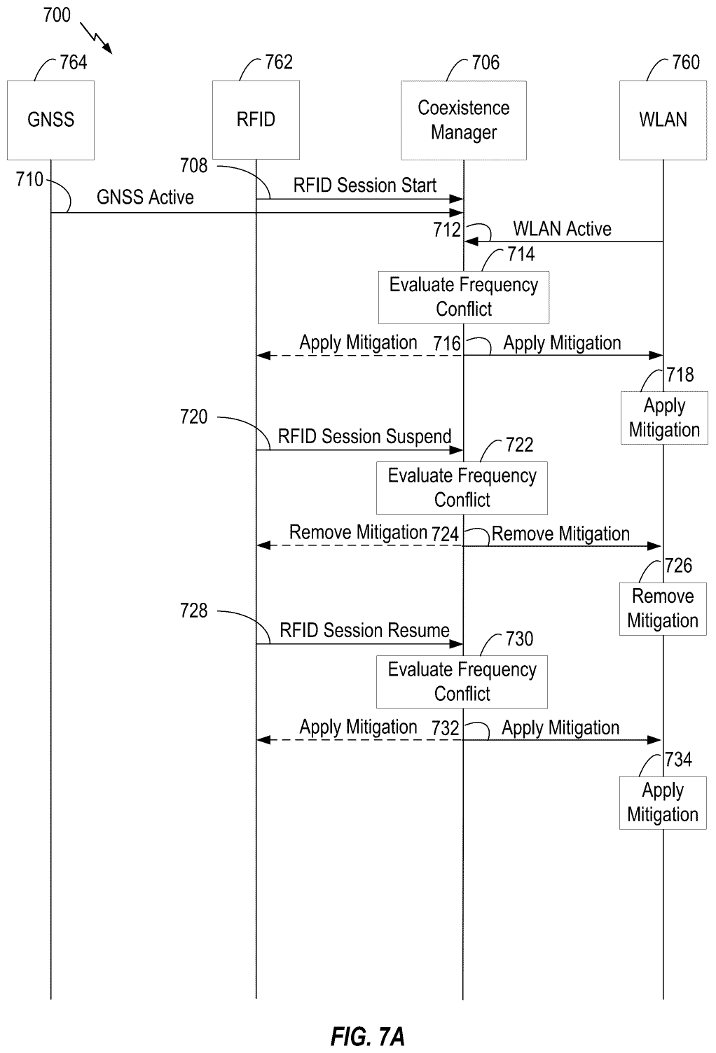

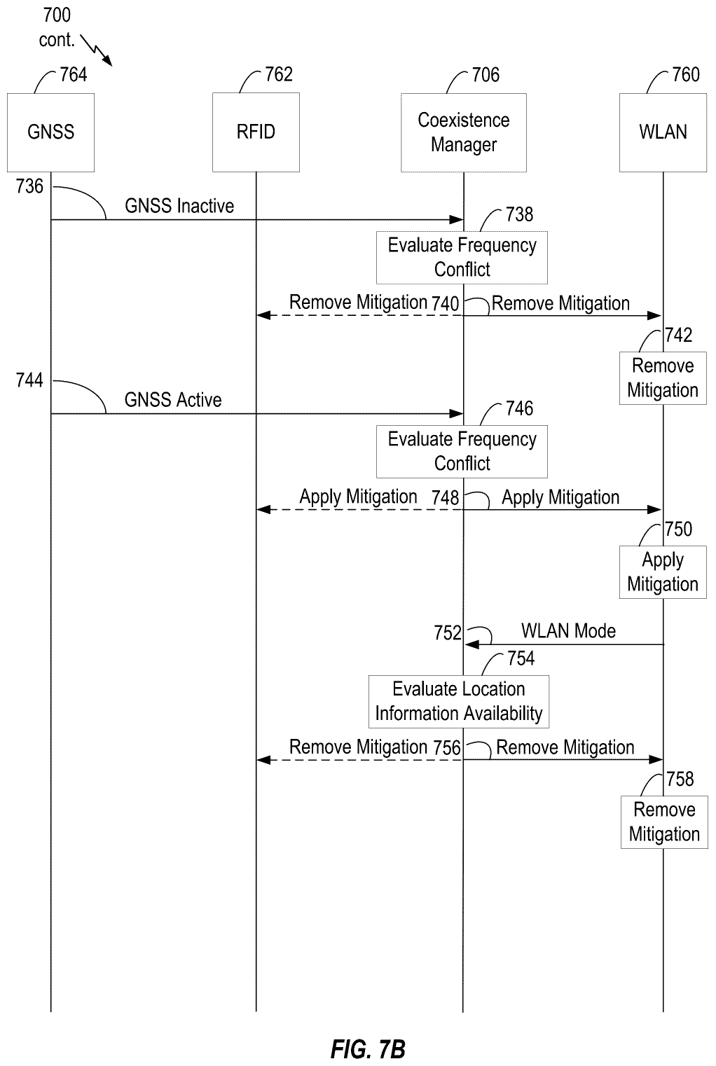

FIGS. 7A and 7B depict a process flow 700 for communications between GNSS circuitry 764 (e.g., GNSS circuitry 364 of FIG. 3), RFID circuitry 762 (e.g., RFID circuitry 362 of FIG. 3), WLAN circuitry 760 (e.g., WLAN circuitry 360 of FIG. 3), and coexistence manager 706 (e.g., coexistence manager 106 of FIGS. 1-3). Thus, the process flow 700 may depict the internal communications among the circuitry of a wireless device to perform coexistence management. In certain aspects, the GNSS circuitry 764, RFID circuitry 762, WLAN circuitry 760, and the coexistence manager 706 may be integrated in the same chip or circuit package and/or distributed among multiple chips or circuit packages.

At 708, coexistence manager 706 receives from RFID circuitry 762 a session start message for an RFID session, which may indicate active RFID operations. The session start message may include an indication of an operating frequency of the RFID circuitry 762. Further, at 710, coexistence manager 706 receives from GNSS circuitry 764 a GNSS active message, which may indicate active GNSS operations. The GNSS active message may indicate an operating frequency of the GNSS circuitry 764.

At 712, coexistence manager 706 receives from WLAN circuitry 760 a WLAN on message, which may indicate active WLAN operations. The WLAN on message may indicate an operating frequency of the WLAN circuitry 760. The WLAN on message may indicate one or more modes of operation (e.g., STA mode, SoftAP mode, peer-to-peer mode, etc.) of the WLAN circuitry 760.

At 714, the coexistence manager 706 may determine a frequency conflict between the active WLAN operations, RFID operations, and GNSS operations (e.g., similar to 508 of FIG. 5). For example, the coexistence manager 706 may determine if there is a frequency conflict between the active WLAN operations, RFID operations, and GNSS operations.

At 716, based on determination of the frequency conflict, the coexistence manager 706 may send control signaling to RFID circuitry 762 and/or WLAN circuitry 760 to apply mitigation techniques for the frequency conflict, such as to perform coexistence management. For example, in certain aspects, the control signaling may indicate a reduced transmit power (e.g., reduced maximum transmit power limit) for RFID circuitry 762 and/or WLAN circuitry 760, or indicate to reduce transmit power. In certain aspects, the control signaling may indicate a channel to avoid or a channel to use for the WLAN circuitry 760. At 718, the RFID circuitry 762 and/or WLAN circuitry 760 apply the mitigation techniques for the frequency conflict.

At 720, the coexistence manager 706 receives from RFID circuitry 762 a session suspend message for the RFID session, which may indicate stopping of active RFID operations. At 722, the coexistence manager 706 may determine there is no frequency conflict between the active WLAN operations and GNSS operations, such as due to the suspended RFID operations. At 726, the coexistence manager 706 may send control signaling to RFID circuitry 762 and/or WLAN circuitry 760 to remove application of mitigation techniques for the frequency conflict, such as to cease to perform coexistence management. At 726, the RFID circuitry 762 and/or WLAN circuitry 760 may remove the mitigation techniques for the frequency conflict.

At 728, the coexistence manager 706 receives from RFID circuitry 762 a session resume message for the RFID session, which may indicate active RFID operations.

At 730, the coexistence manager 706 may determine a frequency conflict between the active WLAN operations, RFID operations, and GNSS operations (e.g., similar to 508 of FIG. 5).

At 732, based on determination of the frequency conflict, the coexistence manager 706 may send control signaling to RFID circuitry 762 and/or WLAN circuitry 760 to apply mitigation techniques for the frequency conflict, such as to perform coexistence management. For example, in certain aspects, the control signaling may indicate a reduced transmit power (e.g., reduced maximum transmit power limit) for RFID circuitry 762 and/or WLAN circuitry 760, or indicate to reduce transmit power. In certain aspects, the control signaling may indicate a channel to avoid or a channel to use to the WLAN circuitry 760. At 734, the RFID circuitry 762 and/or WLAN circuitry 760 apply the mitigation techniques for the frequency conflict.

At 736, the coexistence manager 706 receives from GNSS circuitry 764 a GNSS inactive message, which may indicate stopping of active GNSS operations. At 738, the coexistence manager 706 may determine there is no frequency conflict due to no GNSS operations (or no GNSS operations on a conflicting frequency). At 740, the coexistence manager 706 may send control signaling to RFID circuitry 762 and/or WLAN circuitry 760 to remove application of mitigation techniques for the frequency conflict, such as to cease to perform coexistence management. At 742, the RFID circuitry 762 and/or WLAN circuitry 760 may remove the mitigation techniques for the frequency conflict.

At 744, the coexistence manager 706 receives from GNSS circuitry 764 a GNSS active message, which may indicate active GNSS operations.

At 746, the coexistence manager 706 may determine a frequency conflict between the active WLAN operations, RFID operations, and GNSS operations (e.g., similar to 508 of FIG. 5).

At 748, based on determination of the frequency conflict, the coexistence manager 706 may send control signaling to RFID circuitry 762 and/or WLAN circuitry 760 to apply mitigation techniques for the frequency conflict, such as to perform coexistence management. For example, in certain aspects, the control signaling may indicate a reduced transmit power (e.g., reduced maximum transmit power limit) for RFID circuitry 762 and/or WLAN circuitry 760, or indicate to reduce transmit power. In certain aspects, the control signaling may indicate a channel to avoid or a channel to use to the WLAN circuitry 760. At 750, the RFID circuitry 762 and/or WLAN circuitry 760 apply the mitigation techniques for the frequency conflict.

At 752, the coexistence manager 706 receives from WLAN circuitry 760 a WLAN mode message, which may indicate an STA mode of operation. At 754, the coexistence manager 706 may determine that location information is available from a source other than GNSS (e.g., similar to 510 of FIG. 5). At 756, the coexistence manager 706 may send control signaling to RFID circuitry 762 and/or WLAN circuitry 760 to remove application of mitigation techniques for the frequency conflict, such as to cease to perform coexistence management, such as based on the location information being available from the WLAN. At 758, the RFID circuitry 762 and/or WLAN circuitry 760 may remove the mitigation techniques for the frequency conflict.

Note that the process flow illustrated in FIG. 7 is an example of coexistence management, and aspects of the present disclosure may be applied to additional or alternative techniques for coexistence management. Note that the process flow illustrated in FIG. 7 is described herein to facilitate an understanding of coexistence management, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Wireless Device Operations

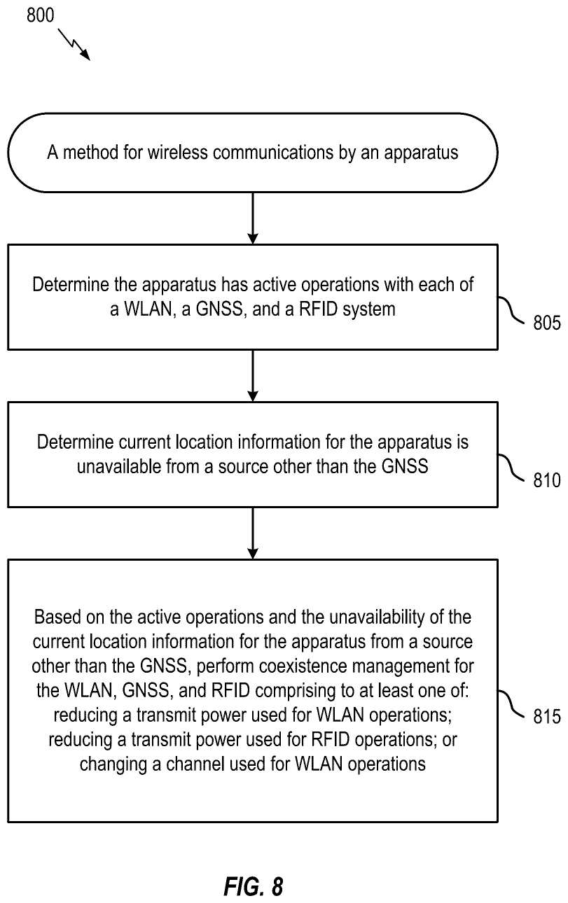

FIG. 8 illustrates example operations 800 for wireless communication. The operations 800 may be performed, for example, by an apparatus, such as a wireless device (e.g., the first wireless device 102 in the wireless communications system 100). The operations 800 may be implemented as software components that are executed and run on one or more processors (e.g., the modem 210 and/or the processor 212 of FIG. 2). Further, the transmission and/or reception of signals by the apparatus in the operations 800 may be enabled, for example, by one or more antennas (e.g., the antenna 220 of FIG. 2). In certain aspects, the transmission and/or reception of signals by the apparatus may be implemented via a bus interface of one or more processors (e.g., the modem 210 and/or the processor 212 of FIG. 2) obtaining and/or outputting signals for reception or transmission.

The operations 800 may optionally begin, at block 805, where the apparatus may determine the apparatus has active operations with each of a WLAN, a GNSS, and a RFID system

Operations 800 then proceed to block 810 with determining current location information for the apparatus is unavailable from a source other than the GNSS.

Operations 800 then proceed to block 815 with, based on the active operations and the unavailability of the current location information for the apparatus from a source other than the GNSS, performing coexistence management for the WLAN, GNSS, and RFID comprising at least one of: reducing a transmit power used for WLAN operations; reducing a transmit power used for RFID operations; or changing a channel used for WLAN operations.

In certain aspects, block 805 includes at least one of: obtaining a session start message for the RFID system; obtaining a GNSS active message for the GNSS; or obtaining a WLAN on message for the WLAN.

In certain aspects, operations 800 further include determining an intermodulation frequency of a first frequency associated with the WLAN operations and a second frequency associated with the RFID operations interferes with a third frequency associated with GNSS operations; and performing the coexistence management is further based on interference of the intermodulation frequency with the third frequency.

In certain aspects, block 810 includes determining the apparatus is not connected to a WLAN access point.

In certain aspects, the apparatus is in at least one of: a software enabled access point mode, a WLAN scanning mode, or a peer-to-peer WLAN connection mode.

In certain aspects, block 815 includes: determining the WLAN operations are prioritized over the RFID operations; and reducing the transmit power used for the RFID operations based at least in part on the WLAN operations being prioritized over the RFID operations.

In certain aspects, block 815 includes changing the channel used for WLAN operations comprising: changing the channel from a first channel within a first frequency band to a second channel within the first frequency band; or changing the channel from the first channel to a third channel within a second frequency band.

In certain aspects, block 815 includes: determining the RFID operations are prioritized over the WLAN operations; and at least one of: reducing the transmit power used for the WLAN operations based at least in part on the RFID operations being prioritized over the WLAN operations; or changing the channel used for the WLAN operations based at least in part on the RFID operations being prioritized over the WLAN operations.

In certain aspects, block 815 includes changing the channel used for WLAN operations comprising changing the channel for WLAN operations to one that, together with a frequency associated with the RFID operations, does not conflict with GNSS operations.

In certain aspects, block 815 includes: determining a non-conflicting channel for the WLAN operations with respect to GNSS operations is unavailable; and based on unavailability of the non-conflicting channel, reducing the transmit power used for the WLAN operations.

In certain aspects, operations 800 further include determining active operations with at least one of the WLAN, GNSS, or the RFID system have stopped.

In certain aspects, operations 800 further include ceasing to perform the coexistence management based on the stopped active operations.

In certain aspects, operations 800 further include determining current location information for the apparatus is available from a source other than the GNSS.

In certain aspects, operations 800 further include ceasing to perform the coexistence management based on the availability of the current location information for the apparatus from a source other than the GNSS.

In certain aspects, the apparatus comprises one or more shared antennas configured for communication with the WLAN, GNSS, and RFID system.

In certain aspects, the apparatus comprises: a first antenna configured for communication with the WLAN; a second antenna configured for communication with the GNSS; and a third antenna configured for communication with the RFID system.

In certain aspects, the apparatus comprises one or more processors comprising: a first modem configured for communication with the WLAN, the GNSS, and the RFID system.

In certain aspects, the apparatus comprises one or more processors comprising: a first modem configured for communication with the GNSS and the RFID system; and a second modem configured for communication with the WLAN.

In certain aspects, the apparatus comprises one or more processors comprising: a first modem configured for communication with the GNSS and the WLAN; and a second modem configured for communication with the RFID system.

In certain aspects, the apparatus comprises one or more processors comprising: a first modem configured for communication with the GNSS; a second modem configured for communication with the WLAN; and a third modem configured for communication with the RFID system.

In certain aspects, the apparatus comprises: a first transmit chain configured for communication with the WLAN; a receive chain configured for communication with the GNSS; and a second transmit chain configured for communication with the RFID system.

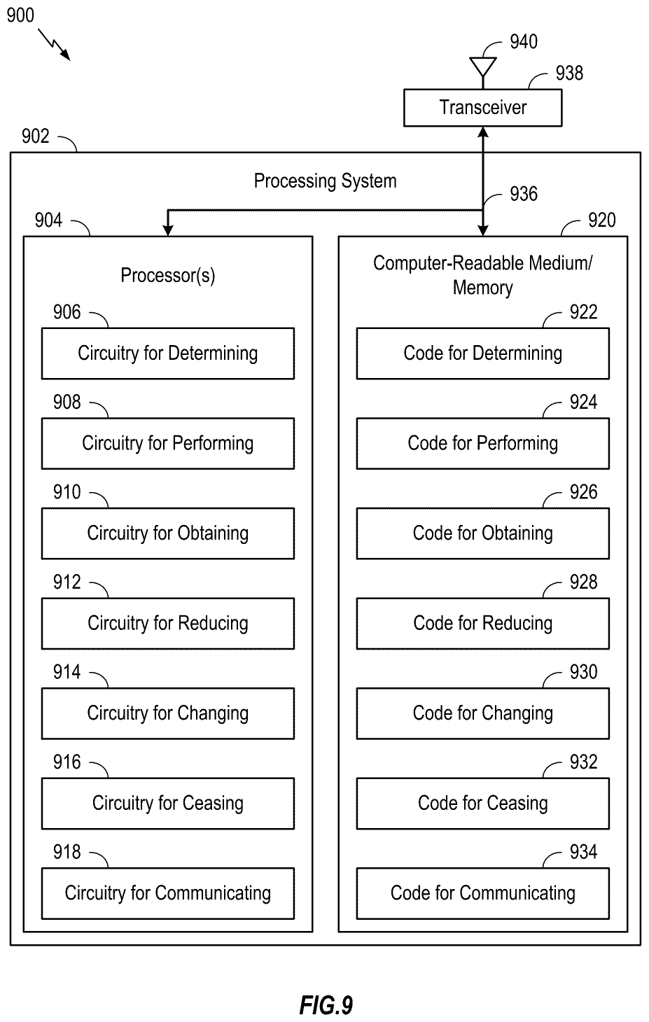

In certain aspects, operations 800, or any aspect related to it, may be performed by an apparatus, such as communications device 900 of FIG. 9, which includes various components operable, configured, or adapted to perform the operations 800. Communications device 900 is described below in further detail.

Note that FIG. 8 is just one example of a method, and other methods including fewer, additional, or alternative operations are possible consistent with this disclosure.

### Example Communications Device

FIG. 9 depicts aspects of an example communications device 900. In some aspects, communications device 900 is a wireless communication device, such as the first wireless device 102 described above with respect to FIGS. 1-3.

The communications device 900 includes a processing system 902 coupled to a transceiver 938 (e.g., a transmitter and/or a receiver). The transceiver 938 is configured to transmit and receive signals for the communications device 900 via an antenna 940, such as the various signals as described herein. The processing system 902 may be configured to perform processing functions for the communications device 900, including processing signals received and/or to be transmitted by the communications device 900.

The processing system 902 includes one or more processors 904. In various aspects, the one or more processors 904 may be representative of any of the modem 210 and/or the processor 212, as described with respect to FIG. 2. The one or more processors 904 are coupled to a computer-readable medium/memory 920 via a bus 936. In certain aspects, the computer-readable medium/memory 920 is configured to store instructions (e.g., computer-executable code) that when executed by the one or more processors 904, cause the one or more processors 904 to perform the operations 800 described with respect to FIG. 8, or any aspect related to the operations described herein. Note that reference to a processor performing a function of communications device 900 may include one or more processors performing that function of communications device 900, such as in a distributed fashion. Reference to one or more processors performing multiple functions may include any one of the one or more processors performing any one of the multiple functions.

In the depicted example, computer-readable medium/memory 920 stores code for determining 922, code for performing 924, code for obtaining 926, code for reducing 928, code for changing 930, code for ceasing 932, and code for communicating 934. Processing of the code 922-934 may enable and cause the communications device 900 to perform the operations 800 described with respect to FIG. 8, or any aspect related to it.

The one or more processors 904 include circuitry configured to implement (e.g., execute) the code (e.g., executable instructions) stored in the computer-readable medium/memory 920, including circuitry for determining 906, circuitry for performing 908, circuitry for obtaining 910, circuitry for reducing 912, circuitry for changing 914, circuitry for ceasing 916, and circuitry for communicating 918. Processing with circuitry 906-918 may enable and cause the communications device 900 to perform the operations 800 described with respect to FIG. 8, or any aspect related to it.

Various components of the communications device 900 may provide means for performing the operations 800 described with respect to FIG. 8, or any aspect related to operations described herein. For example, means for transmitting, sending, communicating, or outputting for transmission may include the TX path 218 and/or antenna(s) 220 of the first wireless device 102 illustrated in FIG. 2 and/or transceiver 938 and antenna 940 of the communications device 900 in FIG. 9. Means for receiving, communicating, or obtaining may include the RX path 222 and/or antenna(s) 220 of the first wireless device illustrated in FIG. 2 and/or transceiver 938 and antenna 940 of the communications device 900 in FIG. 9. Means for determining, performing, reducing, changing, or ceasing may include one or more processors, such as the modem 210 and/or processor 212 depicted in FIG. 2 and/or the processor(s) 904 in FIG. 9.

### EXAMPLE ASPECTS

Implementation examples are described in the following numbered clauses:

Clause 1: A method for wireless communications by an apparatus comprising: determining the apparatus has active operations with each of a WLAN, a GNSS, and a RFID system; determining current location information for the apparatus is unavailable from a source other than the GNSS; and based on the active operations and the unavailability of the current location information for the apparatus from a source other than the GNSS, performing coexistence management for the WLAN, GNSS, and RFID comprising at least one of: reducing a transmit power used for WLAN operations; reducing a transmit power used for RFID operations; or changing a channel used for WLAN operations.

Clause 2: The method of Clause 1, wherein determining the apparatus has the active operations comprises at least one of: obtaining a session start message for the RFID system; obtaining a GNSS active message for the GNSS; or obtaining a WLAN on message for the WLAN.

Clause 3: The method of any one of Clauses 1-2, further comprising: determining an intermodulation frequency of a first frequency associated with the WLAN operations and a second frequency associated with the RFID operations interferes with a third frequency associated with GNSS operations; and performing the coexistence management is further based on interference of the intermodulation frequency with the third frequency.

Clause 4: The method of any one of Clauses 1-3, wherein determining the current location information for the apparatus is unavailable comprises: determining the apparatus is not connected to a WLAN access point.

Clause 5: The method of Clause 4, wherein the apparatus is in at least one of: a software enabled access point mode, a WLAN scanning mode, or a peer-to-peer WLAN connection mode.

Clause 6: The method of any one of Clauses 1-5, wherein performing the coexistence management comprises: determining the WLAN operations are prioritized over the RFID operations; and reducing the transmit power used for the RFID operations based at least in part on the WLAN operations being prioritized over the RFID operations.

Clause 7: The method of any one of Clauses 1-6, wherein performing the coexistence management comprises changing the channel used for WLAN operations comprising: changing the channel from a first channel within a first frequency band to a second channel within the first frequency band; or changing the channel from the first channel to a third channel within a second frequency band.

Clause 8: The method of any one of Clauses 1-5, wherein performing the coexistence management comprises: determining the RFID operations are prioritized over the WLAN operations; and at least one of: reducing the transmit power used for the WLAN operations based at least in part on the RFID operations being prioritized over the WLAN operations; or changing the channel used for the WLAN operations based at least in part on the RFID operations being prioritized over the WLAN operations.

Clause 9: The method of any one of Clauses 1-8, wherein performing the coexistence management comprises changing the channel used for WLAN operations comprises changing the channel for WLAN operations to one that, together with a frequency associated with the RFID operations, does not conflict with GNSS operations.

Clause 10: The method of any one of Clauses 1-5, wherein performing the coexistence management comprises: determining a non-conflicting channel for the WLAN operations with respect to GNSS operations is unavailable; and based on unavailability of the non-conflicting channel, reducing the transmit power used for the WLAN operations.

Clause 11: The method of any one of Clauses 1-10, further comprising: determining active operations with at least one of the WLAN, GNSS, or the RFID system have stopped; and ceasing to perform the coexistence management based on the stopped active operations.

Clause 12: The method of any one of Clauses 1-11, further comprising: determining current location information for the apparatus is available from a source other than the GNSS; and ceasing to perform the coexistence management based on the availability of the current location information for the apparatus from a source other than the GNSS.

Clause 13: The method of any one of Clauses 1-12, wherein the apparatus comprises one or more shared antennas configured for communication with the WLAN, GNSS, and RFID system.

Clause 14: The method of any one of Clauses 1-12, wherein the apparatus comprises: a first antenna configured for communication with the WLAN; a second antenna configured for communication with the GNSS; and a third antenna configured for communication with the RFID system.

Clause 15: The method of any one of Clauses 1-14, wherein the one or more processors comprise: a first modem configured for communication with the WLAN, the GNSS, and the RFID system.

Clause 16: The method of any one of Clauses 1-14, wherein the one or more processors comprise: a first modem configured for communication with the GNSS and the RFID system; and a second modem configured for communication with the WLAN.

Clause 17: The method of any one of Clauses 1-14, wherein the one or more processors comprise: a first modem configured for communication with the GNSS and the WLAN; and a second modem configured for communication with the RFID system.

Clause 18: The method of any one of Clauses 1-14, wherein the one or more processors comprise: a first modem configured for communication with the GNSS; a second modem configured for communication with the WLAN; and a third modem configured for communication with the RFID system.

Clause 19: The method of any one of Clauses 1-18, wherein the apparatus comprises: a first transmit chain configured for communication with the WLAN; a receive chain configured for communication with the GNSS; and a second transmit chain configured for communication with the RFID system.

Clause 20: An apparatus configured for wireless communications, comprising: a first transmit chain configured for communication with a wireless local area network (WLAN); a second transmit chain configured for communication with a radio frequency identification (RFID) system; a receive chain configured for communication with a global navigation satellite system (GNSS); one or more memories; and one or more processors coupled to the one or more memories, the one or more processors being configured to cause the apparatus to: determine the apparatus has active operations with each of the WLAN, the GNSS, and the RFID system; determine current location information for the apparatus is unavailable from a source other than the GNSS; and based on the active operations and the unavailability of the current location information for the apparatus from a source other than the GNSS, perform coexistence management for the WLAN, GNSS, and RFID comprising to at least one of: reduce a transmit power used for transmission of one or more first signals via the first transmit chain; reduce a transmit power used for transmission of one or more second signals via the second transmit chain; or change a channel used for transmission of the one or more first signals via the first transmit chain.

Clause 21: One or more apparatuses, comprising: one or more memories comprising executable instructions; and one or more processors configured to execute the executable instructions and cause the one or more apparatuses to perform a method in accordance with any one of Clauses 1-19.

Clause 22: One or more apparatuses, comprising: one or more memories; and one or more processors, coupled to the one or more memories, configured to cause the one or more apparatuses to perform a method in accordance with any one of Clauses 1-19.

Clause 23: One or more apparatuses, comprising: one or more memories; and one or more processors, coupled to the one or more memories, configured to perform a method in accordance with any one of Clauses 1-19.

Clause 24: One or more apparatuses, comprising means for performing a method in accordance with any one of Clauses 1-19.

Clause 25: One or more non-transitory computer-readable media comprising executable instructions that, when executed by one or more processors of one or more apparatuses, cause the one or more apparatuses to perform a method in accordance with any one of Clauses 1-19.

Clause 26: One or more computer program products embodied on one or more computer-readable storage media comprising code for performing a method in accordance with any one of Clauses 1-19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general purpose processor, an artificial intelligence (AI) processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), a system in package (SiP), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and or like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one or more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for wireless communications, comprising:
one or more memories; and
one or more processors coupled to the one or more memories, the one or more processors being configured to cause the apparatus to:
determine the apparatus has active operations with each of a wireless local area network (WLAN), a global navigation satellite system (GNSS), and a radio frequency identification (RFID) system;
determine current location information for the apparatus is unavailable from a source other than the GNSS; and
based on the active operations and the unavailability of the current location information for the apparatus from a source other than the GNSS, perform coexistence management for the WLAN, GNSS, and RFID comprising to at least one of:
reduce a transmit power used for WLAN operations;
reduce a transmit power used for RFID operations; or
change a channel used for WLAN operations.

2. The apparatus of claim 1, wherein to determine the apparatus has the active operations comprises to at least one of:
obtain a session start message for the RFID system;
obtain a GNSS active message for the GNSS; or
obtain a WLAN on message for the WLAN.

3. The apparatus of claim 1, wherein:
the one or more processors are configured to cause the apparatus to determine an intermodulation frequency of a first frequency associated with the WLAN operations and a second frequency associated with the RFID operations interferes with a third frequency associated with GNSS operations; and
to perform the coexistence management is further based on interference of the intermodulation frequency with the third frequency.

4. The apparatus of claim 1, wherein to determine the current location information for the apparatus is unavailable comprises to:
determine the apparatus is not connected to a WLAN access point.

5. The apparatus of claim 4, wherein the apparatus is in at least one of: a software enabled access point mode, a WLAN scanning mode, or a peer-to-peer WLAN connection mode.

6. The apparatus of claim 1, wherein to perform the coexistence management comprises to:
determine the WLAN operations are prioritized over the RFID operations; and
reduce the transmit power used for the RFID operations based at least in part on the WLAN operations being prioritized over the RFID operations.

7. The apparatus of claim 1, wherein to perform the coexistence management comprises to change the channel used for WLAN operations comprising to:
change the channel from a first channel within a first frequency band to a second channel within the first frequency band; or
change the channel from the first channel to a third channel within a second frequency band.

8. The apparatus of claim 1, wherein to perform the coexistence management comprises to:
determine the RFID operations are prioritized over the WLAN operations; and
at least one of:
reduce the transmit power used for the WLAN operations based at least in part on the RFID operations being prioritized over the WLAN operations; or
change the channel used for the WLAN operations based at least in part on the RFID operations being prioritized over the WLAN operations.

9. The apparatus of claim 1, wherein to perform the coexistence management comprises to change the channel used for WLAN operations comprising to:
change the channel for WLAN operations to one that, together with a frequency associated with the RFID operations, does not conflict with GNSS operations.

10. The apparatus of claim 1, wherein to perform the coexistence management comprises to:
determine a non-conflicting channel for the WLAN operations with respect to GNSS operations is unavailable; and
based on unavailability of the non-conflicting channel, reduce the transmit power used for the WLAN operations.

11. The apparatus of claim 1, the one or more processors are configured to cause the apparatus to:
determine active operations with at least one of the WLAN, GNSS, or the RFID system have stopped; and
based on the stopped active operations, cease to perform the coexistence management.

12. The apparatus of claim 1, the one or more processors are configured to cause the apparatus to:
determine current location information for the apparatus is available from a source other than the GNSS; and
based on the availability of the current location information for the apparatus from a source other than the GNSS, cease to perform the coexistence management.

13. The apparatus of claim 1, further comprising one or more shared antennas configured for communication with the WLAN, GNSS, and RFID system.

14. The apparatus of claim 1, further comprising:
a first antenna configured for communication with the WLAN;
a second antenna configured for communication with the GNSS; and
a third antenna configured for communication with the RFID system.

15. The apparatus of claim 1, wherein the one or more processors comprise:
a first modem configured for communication with the WLAN, the GNSS, and the RFID system.

16. The apparatus of claim 1, wherein the one or more processors comprise:
a first modem configured for communication with the GNSS and the RFID system; and
a second modem configured for communication with the WLAN.

17. The apparatus of claim 1, wherein the one or more processors comprise:
a first modem configured for communication with the GNSS and the WLAN; and
a second modem configured for communication with the RFID system.

18. The apparatus of claim 1, wherein the one or more processors comprise:
a first modem configured for communication with the GNSS;
a second modem configured for communication with the WLAN; and
a third modem configured for communication with the RFID system.

19. A method for wireless communications by an apparatus comprising:
determining the apparatus has active operations with each of a wireless local area network (WLAN), a global navigation satellite system (GNSS), and a radio frequency identification (RFID) system;
determining current location information for the apparatus is unavailable from a source other than the GNSS; and
based on the active operations and the unavailability of the current location information for the apparatus from a source other than the GNSS, performing coexistence management for the WLAN, GNSS, and RFID comprising at least one of:
reducing a transmit power used for WLAN operations;
reducing a transmit power used for RFID operations; or
changing a channel used for WLAN operations.

20. An apparatus configured for wireless communications, comprising:
a first transmit chain configured for communication with a wireless local area network (WLAN);
a second transmit chain configured for communication with a radio frequency identification (RFID) system;
a receive chain configured for communication with a global navigation satellite system (GNSS);
one or more memories; and
one or more processors coupled to the one or more memories, the one or more processors being configured to cause the apparatus to:
determine the apparatus has active operations with each of the WLAN, the GNSS, and the RFID system;
determine current location information for the apparatus is unavailable from a source other than the GNSS; and
based on the active operations and the unavailability of the current location information for the apparatus from a source other than the GNSS, perform coexistence management for the WLAN, GNSS, and RFID comprising to at least one of:
reduce a transmit power used for transmission of one or more first signals via the first transmit chain;
reduce a transmit power used for transmission of one or more second signals via the second transmit chain; or
change a channel used for transmission of the one or more first signals via the first transmit chain.
